(19) United States
(12) Patent Application Publication
(10) Pub. No.: US 2021/0145244 A1
(43) Pub. Date: May 20, 2021

(54) DISHWASHER, IN PARTICULAR DOMESTIC DISHWASHER

(71) Applicant: Miele & Cie. KG, Guetersloh (DE)

(72) Inventors: Andre Bertram, Bielefeld (DE); Tobias Dahms, Hannover (DE); Ralph Steinmeier, Herford (DE); Andreas Nierling, Melle (DE); Nils Schroeder, Bielefeld (DE)

(21) Appl. No.: 16/611,861

(22) PCT Filed: May 18, 2018
(86) PCT No.: PCT/EP2018/063054

§ 371 Date: Nov. 8, 2019

(30) Foreign Application Priority Data
May 23, 2017 (DE) 10 2017 111 187.5

(51) Int. Cl. A47L 15/42

(52) U.S. Cl. CPC A47L 15/4291; A47L 15/4246; A47L 2501/01; A47L 2401/08; A47L 15/4217

(57) ABSTRACT

A dishwasher, in particular a household dishwasher, includes: a washing container having a washing compartment and which receives washing items to be cleaned; and a heat pump device which has an evaporator which is arranged within a tank filled with water. The tank is fluidically connected to the washing container and to a fresh water inlet device. The tank is arranged below the washing container and has a top wall facing a washing container bottom.

### CROSS-REFERENCE TO PRIOR APPLICATIONS

This application is a U.S. National Phase application under 35 U.S.C. § 371 of International Application No. PCT/EP2018/063054, filed on May 18, 2018, and claims benefit to German Patent Application No. DE 10 2017 111 187.5, filed on May 23, 2017. The International Application was published in German on Nov. 29, 2018 as WO/2018/215331 under PCT Article 21(2).

### FIELD

The invention relates to a dishwasher, in particular a domestic dishwasher, comprising a rinsing container providing a washing compartment, which serves to receive items to be washed, and a heat pump device comprising an evaporator arranged inside a tank filled with water. The invention further relates to a method for operating a dishwasher.

### BACKGROUND

Dishwashers of the type mentioned initially are known per se from the prior art. There is therefore no need for a separate printable proof at this point, which is why reference should only be made by way of example to EP 3 141 176 A1 relating to a generic dishwasher.

Previously known dishwashers have a washing container, also called a tub, which provides a washing compartment. This is accessible on the user side via a loading hatch which can be closed in a fluid-tight manner by means of a pivotably mounted washing compartment door. When used as intended, the washing container is used to receive dishes, cutlery and/or similar items that are to be cleaned.

The dishwasher is equipped with a spraying device in the interior of the washing container for applying washing liquid, the so-called washing liquor, to the dishes to be cleaned. This spraying device typically provides rotatably mounted spray arms, wherein as a rule two or three such spraying arms are provided. When used as intended, the items to be cleaned are impinged with washing liquor by means of rotating spray arms.

During operation the washing liquor discharged from the spraying device in the impinges on the items to be cleaned and then collects in a collecting pot of the washing container. The collecting pot is connected to a circulation pump on the one hand and to a drain pump on the other. The circulating pump is used to apply the washing liquor to the spraying unit. When used as intended, it circulates the washing liquor fed into the dishwasher. When a washing program is concluded, the washing liquor is discarded and pumped off by means of the drain pump.

Dishwashers of the type mentioned above are known to be equipped with a heat pump device in order to reduce energy consumption, in particular when the washing liquor is heated, especially because heating the washing liquor in this way accounts for the majority of the energy consumption of a dishwasher.

EP 2 682 038 A2 is known to be a dishwasher with an air water heat pump device. During operation, the heat pump device extracts heat energy from the ambient atmosphere, i.e. the air surrounding the dishwasher, in order to transfer it to the washing liquor circulating inside the dishwasher. For this purpose, the heat pump device is equipped, in a manner per se, with an evaporator, a compressor, a condenser and a flow or circulation circuit fluidically connecting these components. The condenser serves as a heat exchanger by means of which heat energy is transferred from a working medium circulated in the flow circuit of the heat pump device to the washing liquor.

When used as intended, the heat pump device, room air is sucked in for heating the washing liquor by means of fans and conducted via the evaporator of the heat pump device. This results in a cooling of the supplied ambient air, wherein the heat energy extracted from the ambient air is transferred to the working medium, which subsequently evaporates in the evaporator. The working medium, which is then in gaseous form, is then compressed in the compressor and raised to a higher temperature level. Finally, the gaseous working medium is fed into the condenser, where the working medium is liquefied by releasing energy. The heat energy released is used to heat the washing liquor.

The use of water-water-heat pump devices is likewise known from the prior art by way of example from EP 2 206 824 A2 and from EP 3 141 176 A1 already mentioned at the outset. When used as intended, such a heat pump device extracts heat energy not from the ambient atmosphere but from a liquid reservoir. For this purpose, EP 2 206 824 A2 provides a closed water tank which accommodates the evaporator of the heat pump device. During operation, the water stored in the tank is cooled as a result of heat energy withdrawal. In this case, the water can be cooled down to icing. EP 3 141 176 A1 also discloses a water-to-water-heat pump device, but unlike EP 2 206 824 A2 it does have an open water tank.

It is only possible to reuse the dishwasher after a previous washing program has been completed using the heat pump device when the water frozen in the water tank of the heat pump device has thawed again. This is because it only makes sense to use the dishwasher as intended while simultaneously using the heat pump device if the water stored in the water tank has a certain minimum temperature. If the water is still too cool or even frozen after a previous use of the dishwasher, the dishwasher must be used as intended until the minimum temperature has been reached, which can take up to 24 hours if the water is still frozen. Therefore, it is only possible to use the dishwasher as intended once a day using the heat pump device. This is perceived as disadvantageous by the user.

In order to address this problem, designs have been proposed whereby the tank is arranged as close as possible to the washing container. The heat radiation emitted by a washing container that has still been heated after the completion of a washing program in accordance with its intended use is used to thaw the ice in the water tank faster. EP 2 193 741 A2, a coupling tank between the water tank and the washing container, has been proposed as an even more effective way of returning heat to the water tank.

All the solutions described above have in common the disadvantage that the tank must not be completely filled with water in order to provide an equalizing volume for the ice formed during freezing. Otherwise, the water tank would burst during freezing due to the expansion of the frozen water.

For safety reasons, the equalizing volume which must be provided is calculated to be larger than required for the application, especially because as a rule all the water in the tank does not freeze. Therefore, an air cushion is always provided which is located in the tank above the level of water or ice. This air cushion has a detrimental thermal insulating effect so that heat radiation from the washing container can only be insufficiently used for thawing ice in the water tank. It is therefore not possible to achieve significantly faster thawing of ice in the water tank by placing the water tank close to the washing container.

### SUMMARY

In an embodiment, the present invention provides a dishwasher, in particular a household dishwasher, comprising: a washing container comprising a washing compartment and which is configured to receive washing items to be cleaned; and a heat pump device which has an evaporator which is arranged within a tank filled with water, wherein the tank is fluidically connected to the washing container and to a fresh water inlet device, and wherein the tank is arranged below the washing container and has a top wall facing a washing container bottom.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 schematically depicts an inventive dishwasher;

FIG. 2a schematically depicts the dishwasher from the front in accordance with a first operating state;

FIG. 2b schematically depicts the dishwasher from the side according to FIG. 2a;

FIG. 3a schematically depicts the inventive dishwasher from the front in accordance with the second operating state;

FIG. 3b schematically depicts the dishwasher from the side according to FIG. 3a;

FIG. 4a schematically depicts the inventive dishwasher from the front in accordance with a third operating state;

FIG. 4b schematically depicts the dishwasher from the side according to FIG. 4a;

FIG. 5a schematically depicts the inventive dishwasher from the front in accordance with a fourth operating state;

FIG. 5b schematically depicts the dishwasher from the side according to FIG. 5a;

FIG. 6a schematically depicts the inventive dishwasher from the front in accordance with a fifth operating state;

FIG. 6b schematically depicts the dishwasher from the side according to FIG. 6a;

FIG. 7, schematically depicts the volumes provided by the tank and storage tank;

FIG. 8 schematically depicts the inventive dishwasher in accordance with a second embodiment;

FIG. 9 schematically depicts the inventive dishwasher in accordance with a third embodiment;

FIG. 10 schematically depicts the inventive dishwasher in accordance with a fourth embodiment;

FIG. 11 schematically depicts the inventive dishwasher in accordance with a fifth embodiment; and

FIG. 12 schematically depicts the inventive dishwasher in accordance with a sixth embodiment.

### DETAILED DESCRIPTION

Starting from the above, in an embodiment, the present invention provides a dishwasher of the type mentioned at the beginning, which, due to its design, allows water in the water tank of the heat pump device to thaw more quickly.

In contrast to the prior art, for example according to EP 2 206 824 B 1 and EP 2 193 741 A2, the tank of the heat pump device is not closed. Rather, it is connected fluidically on the one hand to the washing container and on the other to a fresh water inlet device. This allows the water in the tank to be discharged as required simply by being fed into the washing container. Furthermore, the supply of fresh water into the tank is permitted by means of the fresh water inlet device connected to it fluidically.

The fluidic coupling of the water tank to the rinsing tank on the one hand and the fresh water inlet device on the other allows the filling level within the tank to be adjusted as required, preferably as a function of a washing program sequence. In particular, it is possible to completely fill the tank after the heat pump device has finished operating, i.e. to fill the water tank until a maximum filling level is reached, so that the ceiling wall closing the tank at the top is wetted on its inside. The formation of an air cushion above the filling level is thus advantageously avoided. Heat radiation from the rinsing tank can thus be maximized and absorbed by the water tank and the water stored in it, resulting in significantly faster thawing of ice in the tank.

The inventive construction makes it possible to keep the fill level variable within the water tank. The filling level can thus be set to a lower level and thus create an air cushion if heat transfer from the washing container to the tank or to the water located therein is to be largely avoided, which is by way of example in the case of the heat pump operation, when the washing liquor and the washing container but not the water tank are to be heated up. If, however, the water in the tank is frozen after the heat pump device has finished operating, the level may be raised with the aim of achieving faster thawing by allowing improved heat transfer from the washing container to the water tank or to the water in it because the rise in level prevents the formation of a heat-insulating air cushion.

In order to optimize a heat transfer from the washing container to the tank, the tank is located underneath the washing container. The volume of space underneath the washing container can preferably be utilized by the tank in such a way that the best possible transfer surface is formed between the washing container on the one hand and the top wall of the tank on the other. This is promoted according to the invention in that the top wall facing the washing container bottom is designed at least in sections obliquely and/or parallel to the washing container or at least substantially parallel. The heat radiation emitted from the bottom of the washing tank during operation can thus be absorbed over a large area by the tank and transferred to the water stored in it while avoiding unnecessary losses. Here, “formed obliquely” means that the top wall forms an angle with the plane perpendicular to the direction of gravity. In particular, the top wall is arranged obliquely in this sense almost over its entire area. “Formed parallel or at least substantially parallel to the washing container” means here that the top wall to the washing container bottom maintains a constant or virtually constant distance from the washing container bottom virtually over its entire area. In particular, the top wall thus at least largely follows the contour of the bottom of the washing container, which is inclined towards the collecting pot located centrally in the washing container.

In this context, it is preferable that the surfaces involved in the heat exchange, i.e. the imitating surfaces on the one hand and the absorbing surfaces on the other, have a high c value. It is therefore especially preferable to equip the washing container bottom on the tank side with a heat radiation absorbing layer, in particular >a bitumen layer, the value of which is 0.9, for example approximately 0.95. The tank is preferably made of a plastic, wherein plastic with a given value of 0.70 to 0.90 should be selected.

In order to achieve a vibration-decoupled arrangement of the tank, it is preferable for the tank to be arranged below the washing container, leaving a gap between the top wall and the bottom of the washing container. Due to this spaced array, any vibrations emanating from the heat pump and thus from the tank are not transmitted to the washing container.

On the other hand, it is expedient for an optimized heat transfer to align the tank as close as possible to the washing container, wherein the distance between tank and washing container should, as far as possible, be only a few millimeters. According to the invention, It is therefore proposed that the distance between the top wall and washing container bottom is between 3 mm and 30 mm, preferably between 5 mm and 20 mm. This distance is maintained in particular over the entire or almost entire surface of the top wall. Otherwise, since free convection between tank and washing container is not to be avoided and the installation space inside the dishwasher is also limited, the smallest possible distances between the washing container and the tank should be selected.

In accordance with another feature of the invention, the tank has a first compartment and a second compartment, wherein the first compartment provides a nominal volume and the second one provides a filling volume. First and second compartments may be structurally separated from one another. Alternatively, the first and second compartment jointly form a common volume space.

The nominal volume provided by the first compartment of the tank is dimensioned in such a way that it accommodates the quantity of water for the intended use of the heat pump device. At the beginning of operation of the heat pump device, the nominal volume is completely filled with water.

If the heat pump device is used as intended, the water stored in the tank may at least partially freeze. As a result, expansion occurs. In order to prevent the tank from bursting as a result of such expansion, the total volume provided by the tank shall be greater than the nominal volume.

The difference between total volume and nominal volume is the so-called filling volume. In this case, the total volume or the filling volume in relation to the nominal volume is dimensioned in such a way that even if the water stored in the tank is completely frozen in accordance with the nominal value, the filling volume is sufficient to be able to compensate for the expansion resulting from freezing. Consequently, even if the water in the tank completely freezes, the total volume provided by the tank is not completely exhausted.

After the heat pump device has finished operating, an amount of water corresponding to the filling volume is supplied to the tank. As a result, this leads to a level rise in the tank until the inside surface of the top wall of the tank is wetted. This is irrespective of whether or not ice is still present in the tank as a result of the preceding operation of the heat pump device. Even if the ice in the tank thaws and the resulting expansion caused by ice formation is recirculated, the quantity of water supplied is sufficient to ensure wetting of the internal top wall in any case, since the nominal volume and the filling volume make up the total volume provided by the tank.

The filling volume provided by the tank, however, not only provides burst protection in the event of ice formation, it also provides a thermally insulating air cushion between the surface of the water stored by the tank and the inside of the top wall during operation of the heat pump device. This minimizes unwanted heat transfer from the washing container to the water stored in the tank during operation of the heat pump device. Only when the operation of the heat pump device is terminated as intended and heat transfer from the washing container to the tank is desired for thawing the ice located in the tank is a tank filling with water carried out to expel the air cushion.

In accordance with another feature of the invention, a storage tank is provided that is in fluidic connection with the tank, wherein the storage tank provides storage volume. In this case, the storage volume can preferably be dimensioned in such a way that it is equal to or in line with the filling volume.

After the heat pump device has finished operating, water is to be supplied to the tank in an amount corresponding to the filling volume. If there is ice in the tank, which is the case after operation of the heat pump device, the residual volume in the tank is not sufficient to absorb this quantity of water. According to the invention, the storage tank with a fluidic connection to the tank is therefore provided. This serves as an expansion tank for the tank. As soon as water is supplied to the tank in an amount corresponding to the filling volume, the residual volume in the tank is filled. The tank is then completely filled. The difference between filling volume and residual volume is temporarily stored in the storage container. As a result of thawing the ice in the tank, the expansion previously formed as a result of the formation of ice occurs, so that the water temporarily stored in the storage container flows downstream into the tank. As soon as the ice in the tank is completely thawed, the water temporarily stored in the storage tank is also completely transferred to the tank so that the tank is now completely filled exclusively with water at such a level that the nominal volume and the filling volume are completely filled, i.e. the inside surface of the top wall is wetted. An air cushion which has previously been in the tank is thus completely expelled or displaced.

In accordance with a further feature of the invention, the storage tank is preferably arranged above the tank. This has the advantage that water temporarily stored in the storage tank can flow downstream into the tank by the force of gravity. In this respect, additional means, in particular pumps for transferring water from the storage container into the tank, are not required.

In accordance with a further feature of the invention, the tank is intended to be connected to the fresh water inlet device by means of a fluidic connection to the storage tank.

The fresh water inlet device can be a fresh water connection, a water pocket on the device side or another intermediate container. It is decisive that, if necessary, fresh water is supplied to the water tank via the fresh water inlet device, specifically with interposition of the storage tank. The fresh water therefore initially flows into the storage tank, fills the storage volume at least partially, if necessary, and then reaches the water tank via a corresponding fluidic connection. The filling of a water pocket with softening device in the device has the advantage that it is typically equipped with an impeller meter for detecting the amount of water let in. The water tank can thus be filled as required in a simple manner and without additional sensors.

Whereas, in the interests of a simplified construction, it is preferable when the tank and washing container are integrally formed and therefore forming a water storage container. Alternatively, the tank and the storage tank form two separate components which, for example, are fluidically connected via a hose connection.

It is preferable that the storage tank is at least partially or completely laterally adjacent to the washing container. Such an embodiment is advantageous for several reasons. On the one hand, the installation space located below the storage container is available to the tank. On the other hand, the total available area for receiving the heat radiation emanating from the washing container is decisive. The heat radiation is to be absorbed in order to heat or thaw the water in the tank after the heat pump device has finished operating. At this time, any water temporarily stored in the storage container is present, which can only flow downstream into the tank when the ice in the tank has thawed. Due to the secondary arrangement of the storage container to the washing container, the heat radiation discharged laterally from the washing container can be received by the storage container and transferred to the water temporarily stored there. Preheated water can therefore already flow in the tank into the storage tank. The thawing process is thereby positively influenced.

In accordance with another feature of the invention, the tank and/or the storage container are connected to a vent and/or an overflow. This design measure ensures that the tank and storage container can be vented in the event of both emptying and filling, which permits low-noise outflow and inflow. The overflow also ensures that undesired overfilling of the tank or of the storage container cannot occur.

The tank ventilation preferably opens into the storage tank. This results in a simple structural design, in particular in the case of a one-piece design of tank and storage tank.

It is also advantageously provided that the tank ventilation is formed at the highest point of the obliquely running top wall of the tank in the height direction. This not only ensures that the tank can be completely ventilated in the event of ventilation, but also, in particular, that when the tank is filled with water, the inside surface of the tank top wall is completely wetted. This effectively prevents the formation of even the smallest undesirable air cushion when the tank is completely filled with water.

The tank or storage tank is arranged next to the washing container as closely as possible so that a maximum heat transfer from the washing container to the tank or the water stored in it can take place. However, a direct connection of the tank or storage tank to the washing container is to be avoided in order to avoid vibrational transmissions. In this respect, the inventive embodiment allows a vibration decoupling of washing container and water tank to be provided, in particular according to the teaching according to EP 2 193 741 A2, which is not possible with the construction known from the prior art because the coupling tank is interposed.

In accordance to another feature of the invention, a pump and/or a drain valve is/are integrated in the fluidic connection between the washing container and the tank.

At the beginning of a washing program, the water in the tank above the nominal volume must first be removed from the tank and fed to the washing container. For this purpose, a pump is provided in accordance with a first embodiment. To form the simplest possible construction, the tank outlet for transferring water into the washing container in the height direction is designed in such a way that the nominal volume is adjusted as soon as the level has reached the water outlet. In the case of a pump, air is then sucked in through the pump.

A drain valve can be provided as an alternative to the pump. In this case, the tank is arranged side by side in the height direction of the washing container or a collecting pot into which the washing container opens fluidically in such a way that the water flows out of the tank via the water outlet solely on account of the prevailing force of gravity until the level has reached the height of the outlet opening.

In accordance with a special embodiment, the tank is intended to have a base plate and a hood which is supported by it and provides the top wall. The base plate and the hood are connected to each other in a watertight manner and together enclose the volume space provided by the tank.

Inside the hood there may be an annular wall, also supported by the base plate, surrounding the nominal volume provided by the tank. In this embodiment, the annular wall is preferably arranged at a distance from the hood with the encircling of a circumferential annular gap.

This construction has the advantage that, if necessary, an air cushion can be created which not only forms on the upper side of the nominal volume but also surrounds it annularly. If necessary, this provides improved thermal insulation compared to the washing container. If necessary, the air cushion can be expelled by flooding the entire volume space enclosed by the hood with water, including the annular gap formed between the ring wall and the hood.

Furthermore, the invention is proposed to be a method for operating a dishwasher of the type described above, in which water in the tank above the nominal volume is supplied to the washing container at the beginning of a washing program and, after the operation of the heat pump device has finished, a quantity of water corresponding to the filling volume is supplied to the tank.

In accordance with the implementation of the process proposed by the invention, it is intended that the level in the tank is initially set to nominal volume at the beginning of the washing program, the purpose of which is to discharge excess water from the tank into the washing compartment. At the beginning of a washing program, this process step ensures that the quantity of water required for the heat pump equipment to operate properly is in the water tank. Among other things, this is dimensioned in such a way that ice formation during heat pump operation does not result in complete filling of the total volume space provided by the tank.

As soon as an operation of the heat pump device, which is known from the prior art, has ended and as a result of which the water in the tank is at least partially frozen, fresh water is supplied to the tank in accordance with a second process step in an amount corresponding to the filling volume. As a result of this process step, the tank of the heat pump device is completely filled with water, so that the formation of an air cushion between the inner sides of the top wall of the water surface is avoided. Heat radiation emitted by the washing container can thus reach the water stored by the tank directly, i.e. without interposition of a heat-insulating air cushion, resulting in a heat input with the positive effect of faster defrosting than is known from the prior art.

If there is ice inside the tank, the amount of water to be supplied is the same as the residual volume in the tank. This excess water is temporarily stored in the storage tank, which is fluidically coupled to the tank. Water flows out of the storage tank in accordance with the progress of the thawing of ice in the tank, so that the storage tank is completely emptied when no more water is present in the tank after thawing. Since the amount of water detected corresponds to the filling volume, the tank is completely filled with water after the thawing process is complete.

In terms of the process, it is therefore intended that at the beginning of a washing program, an air cushion is formed between the surface of the water in the tank and the inner surface of the top wall of the tank. The formation of this air cushion is achieved by supplying water in the tank above the nominal volume to the washing container at the beginning of a washing program. At the beginning of a washing program, the formation of such an air cushion is desired, because it is first necessary to heat the washing liquor or the washing container so that heat dissipation from the washing container to the tank or to the water contained in it is largely avoided. The thermally insulating air cushion thus minimizes undesirable heat transfer.

In terms of the process, it may be intended in accordance with a further feature that, after the heat pump device has finished operating, a cushion of air between the surface of the water in the tank and the inner surface of the top wall of the tank is displaced as a result of the water supply. At this stage of the washing program, the water in the tank may be frozen, wherein it is desired that the heat pump device can be restored to operational readiness as soon as possible by thawing the ice. An air cushion in the tank is a hindrance to thawing the ice, since heat transfer from the washing container to the tank is adversely affected. In terms of this process, it is therefore intended to fill the tank with water in a manner already described above so that the air cushion is expelled between the water surface and the inside of the top wall. An optimized transfer of heat from the washing container to the water in the tank can then take place.

After ice formation, there is a residual volume in the tank that has not yet been used. This is typically less than the filling volume, i.e. the amount of water to be replenished. For this reason, the storage tank already described above is provided so that the storage volume provided by the storage tank serves as a compensation volume for the tank in terms of the process. Water to be added to the tank can be temporarily stored, especially in the storage tank, until the ice in the tank has thawed completely.

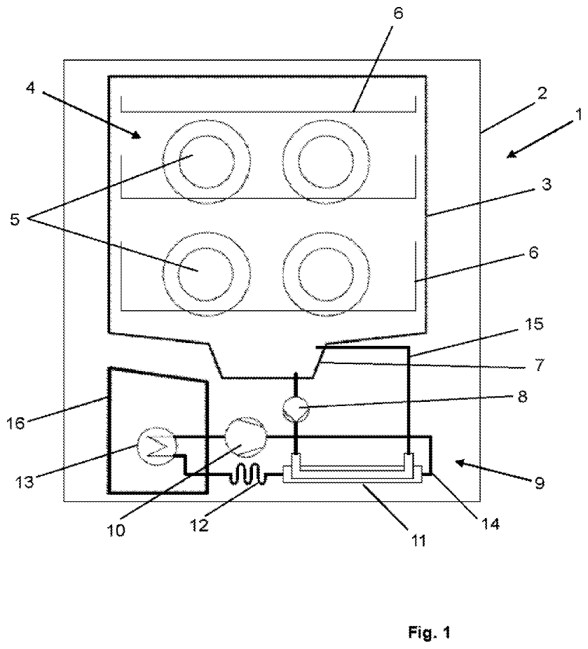

FIG. 1 depicts a dishwasher 1 according to the invention in purely schematic representation.

The dishwasher 1 has a housing 2 which accommodates a washing container 3, among other things. The washing compartment 3 in turn provides a washing compartment 4 which, when used as intended, serves to accommodate items 5 to be cleaned.

A spraying device arranged inside the washing container 3 serves to feed washing items 5 to be cleaned with washing liquor. Preferably, such a spraying device has spray arms which are each arranged rotatably inside the washing container 2.

In the exemplary embodiment shown, washing baskets 6 serve to hold the items 5 to be cleaned, wherein three such washing baskets 6 are provided.

The washing compartment 4 opens into a collecting pot 7 of the washing container 3 to which a circulating pump 8 is fluidically connected. The spray device is fluidically connected to the circulating pump 8 via corresponding supply lines. When used as intended, the spraying device can thus be fed with washing liquor by means of the circulating pump 8.

The dishwasher 1 also has a heat pump device 9. This comprises a compressor 10, a condenser 11, an expansion element in the form of a throttle 12, an evaporator 13 and a flow circuit 14 which fluidically connects these building components with each other and in which a working medium is conveyed.

The evaporator 13 is arranged within a tank 16 which is filled with water 20 as heat transfer medium.

When the heat pump device 9 is used as intended, heat is transferred from the working medium in the flow circuit 14 of the heat pump device 9 to the washing liquor with the aid of the condenser 11. For this purpose, a circulation circuit 15 is provided which is connected to the circulating pump and serves to circulate wash liquor. The thermal energy released during operation in the condenser 11 by liquefaction of the working medium is therefore carried forward to the washing liquor circulating in the circulation circuit 15, for which purpose an appropriately designed heat exchanger is provided.

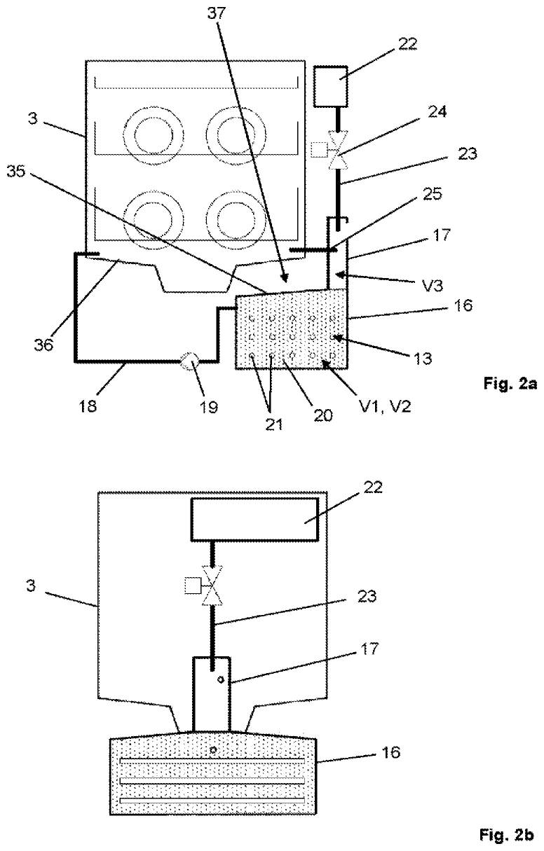

As can be seen from the following FIGS. 2a to 6b, the tank 16 is fluidically connected to the washing container 3. For this purpose, a line 18 is provided, which fluidically connects the tank 16 to the washing container 3. A pump 19 is integrated in line 18 so that water 20 in the tank 16 can be pumped off during normal operation and fed to the washing container 3 via line 18. Alternatively, it may also be provided that the line 18 opens into the collecting pot 7, as can be seen, for example, in FIG. 8.

The tank 16 is also fluidically connected to a fresh water inlet device 22. This fresh water inlet device 22 can be a fresh water connection to the public water network or water pocket on the device side, in particular a water inlet pocket with an integrated softening device. The fresh water inlet device 22 is fluidically connected to the water tank 16 by means of a line 23 so that fresh water can flow into the tank 16 if necessary. A valve 24 is integrated into the line 23 in a known manner, by means of which the line 23 can be opened or closed as required.

As the FIGS. 2a to 6b further show, a storage tank 17 is provided which is fluidically connected to the tank 16. In the exemplary embodiment shown, the storage tank 17 is connected between the fresh water inlet device 22 and the tank 16 so that the fresh water inlet is connected to tank 16 with the storage tank 17 interposed.

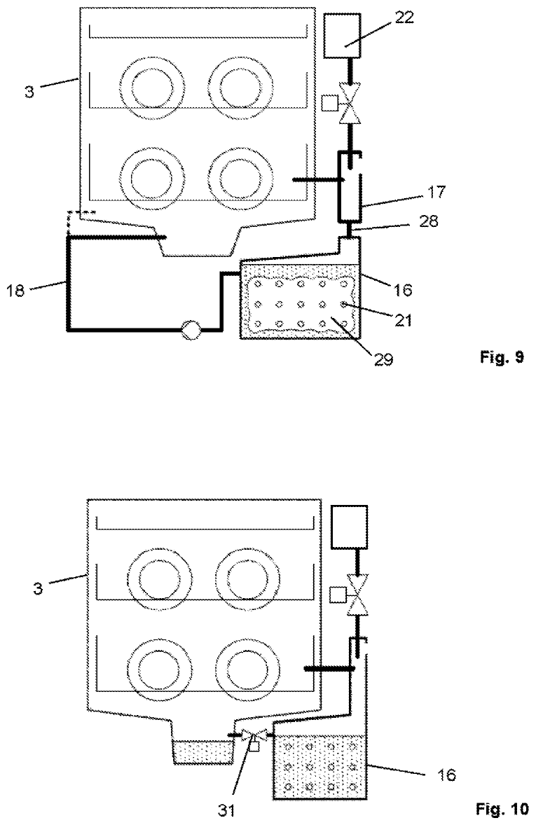

FIGS. 2a to 6b show an embodiment of the dishwasher 1, in which the storage container 17 and the tank 16 are designed as a one-piece container unit. The embodiment variant according to FIG. 9 shows an embodiment in which the tank 16 and the storage tank 17 are formed separated from one another and fluidically coupled to one another via a connecting line 28.

An embodiment according to FIG. 9 may involve installation advantages, in particular when the installation space located between the washing container 3 and the device base is fissured and therefore a separate arrangement of the storage container 17 and the tank 16 cannot be avoided.

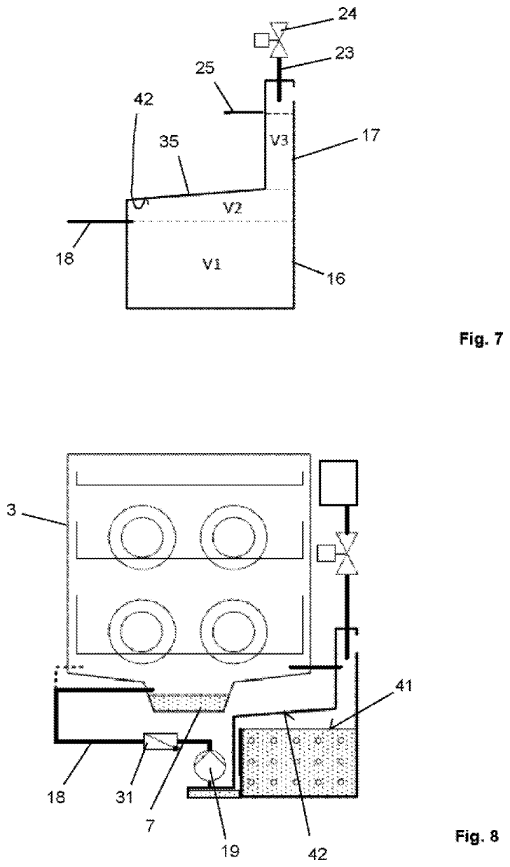

As depicted in particular in the schematic representation of FIG. 7 the tank 16 provides a nominal volume V₁ and a filling volume V₂. In sum, the nominal volume V₁ and the filling volume V₂ result in the overall tank volume provided by the tank 16. However, the storage tank 17 provides the supply volume V₃. The supply volume V₃ is equal to or greater than the filling volume V₂ so that the storage container 17 can absorb the overall expected expansion volume caused by an ice formation in the tank 16.

The storage tank 17 is fluidically coupled to the washing container 3 via an overflow 25. The overflow 25 ensures that the storage tank 17 is not overfilled if fresh water is introduced from the fresh water inlet device 22. In the height direction, the supply volume V₃ is thus determined by the opening of the overflow 25 into the storage container 17.

The dishwasher construction described above allows the following mode of operation.

The operating mode depicted in FIGS. 2a and 2b shall apply before the start of any washing program to be carried out. In accordance with this operating mode, the tank 16 is completely filled with water 20, i.e. the nominal volume V₁ and the filling volume V₂ are emptied of air and contain only water 20. However, the storage tank 17 is emptied.

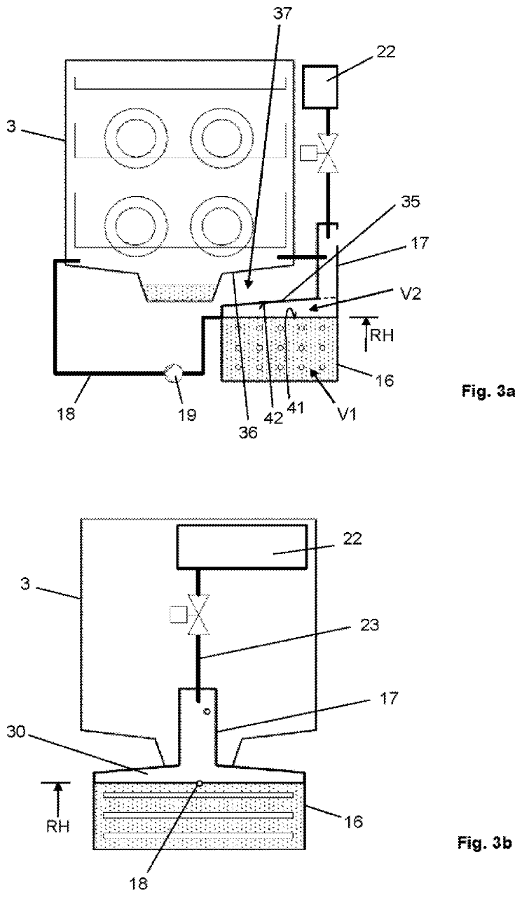

When the washing program starts, excess water 20 in the tank above the nominal volume V₁ is supplied to the washing container 3. FIGS. 3a and 3b show this. In this case, the tank 16 is emptied up to a reference height RH which, in the depicted exemplary embodiment, results from the outlet parts of the line 18 into the tank 16. In accordance with this operating mode, the nominal volume V₁ provided by the tank is completely filled with water 20 whereas the filling volume V₂ serves as an air cushion 30. The air cushion 30 represents a thermally insulating layer, so that thermal energy introduced into the washing liquor and the washing container 3 during the further course of the washing program is not inadvertently transferred into the water stored by the tank 16 as a result of heat radiation or convection. Air cushion 30 thus acts as an insulating layer between washing container 3 and water 20.

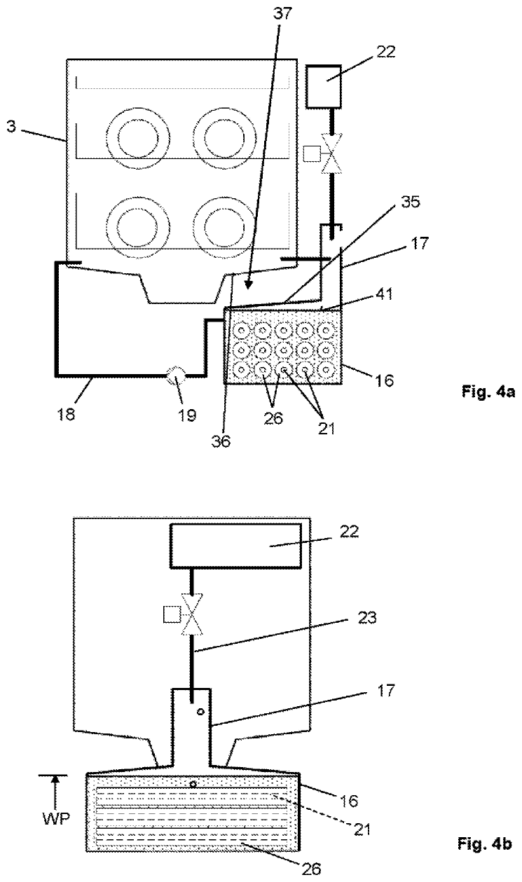

As a result of operation of the heat pump device 9 the evaporator tubes 21 of the evaporator 13 arranged within the tank 16 ice, resulting in the formation of an ice coating 26 around the evaporator tubes 21. Due to the ice formation, the fill level within the tank 16 rises to a water level WP, as depicted in FIGS. 4a and 4b. Part of the filling volume V₂ serves as compensation volume, so that the level rise due to ice formation does not cause the tank 16 to burst. In this case, the filling volume V₂ is dimensioned with regard to its shape in such a way that complete freezing of the water in the tank 16 is permitted without the filling volume V₂ being completely filled up as a result of the level increase. The geometrical design of tank 16 is therefore designed in such a way that the filling volume V₂ is sufficient to absorb the ice produced during freezing, preferably in such a way that the ice does not reach the top wall. For an optimized venting during a filling operation of the tank 16 with an amount of water equivalent to the filling volume V₂ the top wall is inclined, preferably at least partially parallel to the bottom of the washing container 36.

The ice mass produced when the dishwasher 1 is heated may vary due to different loadings of the dishwasher 1. Thus, the adjusting water level WP also varies. Under maximum icing, the water level WP or the ice layer in the tank 16 preferably does not reach the inner surface 42 of the top wall 35.

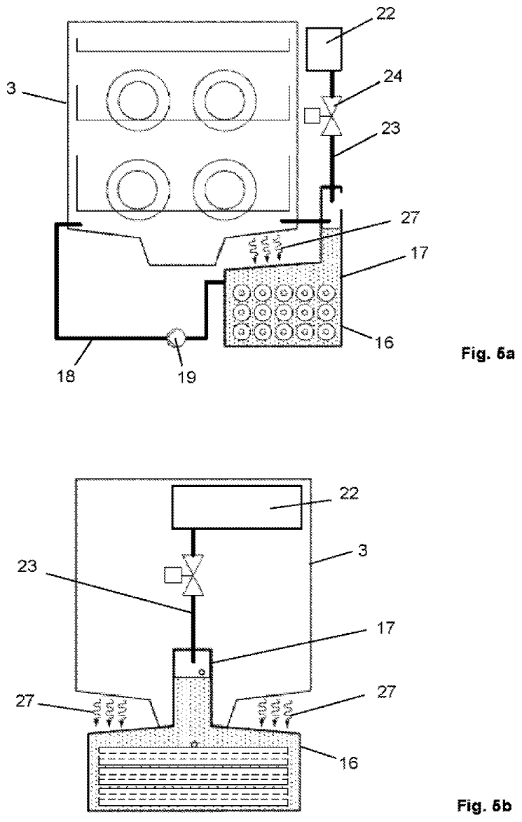

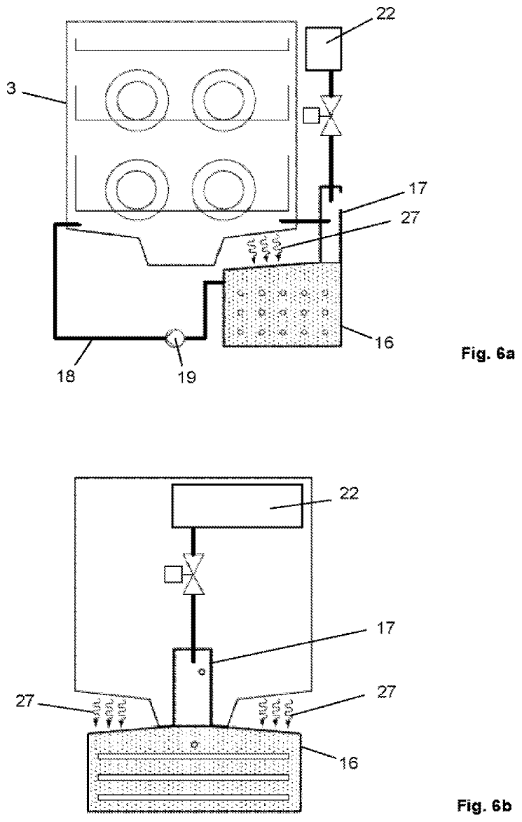

After the operation of the heat pump device 9 has ended, fresh water is supplied from the fresh water inlet device 22 to the tank by interposition of the reservoir 17 in an amount corresponding to the filling volume V₂. The supply of this quantity of water ensures that the tank 16 is completely filled with water after the ice has completely thawed, as depicted in FIGS. 6a and 6b.

Before the ice in tank 16 is completely thawed, the residual volume available in the tank is smaller than the filling volume V₂. When water is added in a quantity of the filling volume V₂, at least part of the storage tank 17 is filled, which serves as an intermediate storage tank for tank 16, as shown in FIGS. 5a and 5b.

The inventive process procedure thus provides that, after the heat pump device has finished operating, sufficient water is to be supplied to the tank 16 that after the ice in the tank 16 has thawed, the tank 16 is completely filled with water again. This quantity of water to be supplied corresponds to the filling volume V₂. Since the free volume still present in the tank 16 is not sufficient to absorb this quantity of water due to the ice still present in the tank 16, the water to be supplied to the tank 16 is temporarily stored in the storage container 17.

Since the storage container 17 is preferably laterally adjacent to the washing container, heat can be transferred from the washing container not only to the water 20 located in the tank 16 but also to the water temporarily stored in the storage container 17. This has the advantage that already preheated water flows out of the container 17 into the tank 16. Water flows out of the storage tank 17 in accordance with the thawing process until the state corresponding to the FIGS. 6a and 6b is reached.

In the course of the further rinsing program, heat radiation 27 is emitted as a result of the preceding heating of washing liquor, washing container 3 and washing items 5, also in the direction of tank 16. Since there is no longer any air cushion 30 due to the complete filling of all volumes with water, the heat radiation 27 can act directly on the tank 16 and the water 20 it stores without the interposition of a thermally insulating layer. As a result, the heat transfer from the washing container 3 to the tank 16 is maximized so that the ice in the tank 16 thaws rapidly. This situation is illustrated in FIGS. 5a and 5b.

As a result of the coat of ice 26 melting, the water level drops again. To such an extent that the water stored in the storage tank V₃ can be completely transferred from the storage tank 17 into the tank 16 in order to fill up the filling volume V₂. The result is the situation depicted in FIGS. 6a to 6b, where tank 16 is completely filled with water, whereas storage tank 17 is empty. The washing program can now be terminated so that a new washing program starts with this operating mode, as already described in the introduction to FIGS. 2a and 2b.

The storage of the water in the tank 16 until the start of a next washing program has the advantage that the replenished water cannot be lost in order to avoid an air cushion 30 but can be reused as initial water quantity in a subsequent washing program. Alternatively, it may be intended to empty the tank 16 again at the end of a washing program so that only the nominal volume V₁ provided by the tank 16 is filled with water. However, it is preferable to allow the tank 16 to be filled completely with water until the start of a next washing program, since the storage of the filling volume V₂ until the next washing program offers the advantage that, even when the machine is switched off, heat recovery or tank regeneration is also possible beyond the end of a washing program. Since thawing takes much longer than the washing program, it is therefore the preferred variant not to discard an amount corresponding to the quantity of water supplied or to be supplied with the completion of a washing program, so that even after a program has ended on the tank 16,1 more energy can be transferred from the washing compartment and in particular from the loading than would be possible with the formation of an air cushion as a result of water discharge.

In order to ensure as effective a heat transfer as possible, the tank 16 is arranged as close as possible to the washing container 3. In this case, the tank and washing container form a gap 37 between them, which in particular achieves vibration decoupling.

FIG. 8 shows an alternative embodiment of the inventive dishwasher. In contrast to the above-explained construction, a tank 16 with a controlled pump 19 and additional check valve 31 is provided in accordance with this embodiment. The tank 16 is constructed in such a way that the area with the pump 19 connected cannot freeze, which in this case is realized by creating a suction area separated by a barrier for the actual tank 16. As an alternative to the opening of conduit 18 into the washing container 3, an opening of conduit 18 into the collecting pot 7 can also be provided.

FIG. 9 shows another embodiment of the supply container 17 and tank 16 which are not designed as a one-piece container, but separately from one another. A connecting line 28 serves for the fluidic connection of tank 16 and tank storage 17.

FIG. 9 also shows, purely by way of example, a possible ice block 29. The separate embodiment of tank 16 and tank storage 17 can be advantageous in particular for large expansion volumes.

FIG. 10 shows another embodiment with a drain valve 31 instead of a pump 19. In accordance with this design, the tank 16 and the collecting pot 17 are arranged side by side in such a way that the tank 16 can be emptied at reference height RH by gravity alone. In order to prevent the tank 16 from being contaminated in the event of backflow from the collecting pot 7, the valve 31 is preferably designed in such a way that it can open only under hydrostatic pre-pressure from the tank 16 and the storage tank 17. If there is counterpressure from the collecting pot 7, it remains closed. This ensures that when the drain pump is defective, no washing liquor can pass from the collecting pot 7 into the tank 16.

FIG. 11 schematically shows another embodiment in which a suction lifter 32 downstream of the valve 31 is provided. This prevents deposits and residue of washing liquor from building up.

In order for the filling volume V₂ to flow out of tank 16 into the collecting pot 7 by gravity, the collecting pot 7 must be able to hold at least the filling volume V₂ below its connection line. Otherwise, the tank 16 would not be drained at the reference height. Contamination by residues in the collecting pot 7 would then be possible.

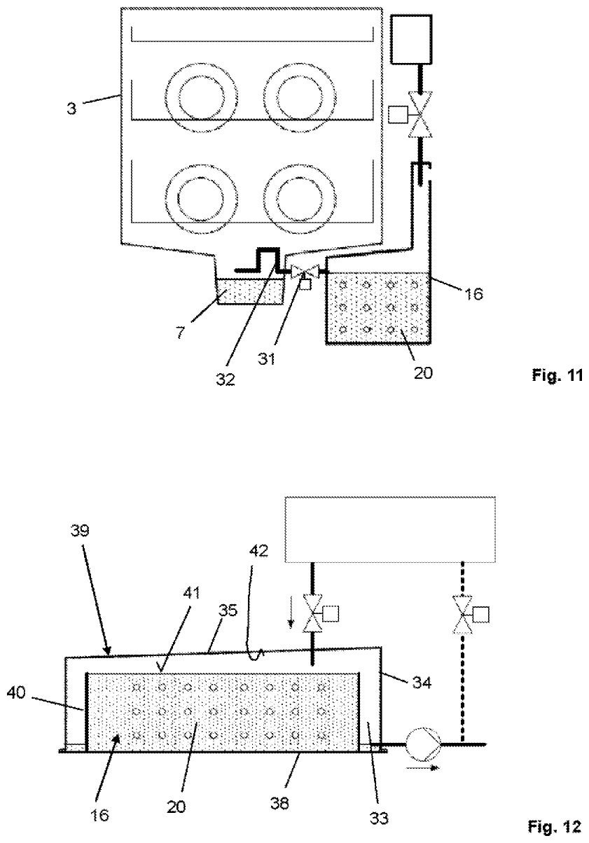

FIG. 12 shows in a schematic depiction a further embodiment, in which a tank variant with a plurality of heat transfer surfaces is provided. The tank 16 has a base plate 38. This carries a watertight connected hood 29, which comprises the top wall 35 as well as a circumferential wall 34.

A circumferential annular wall 40 is arranged within the hood 39 and is spaced apart from the wall 34 of the hood 39 with the aid of an annular gap 33.

The above-described construction allows, if necessary, not only an air cushion to be formed between the water surface 41 and the inner surface 42 of the top wall 35 but also a circulating air cushion defined by the annular gap 33.

The circumferential annular gap 33 may be between 3 mm and 10 mm, preferably between 5 mm and 8 mm. Tank 16, for example, is filled from above through a water pocket, with the nozzle of the water inlet at the tank opening into the tub. Of course, the connection can also take place laterally or from below. The tank 16 can be emptied by one or more valves or pumps. These emptying means are characterized by the fact that they open from the annular gap near the bottom. Thus, the upstanding inner walls form the actual tank 16 and at the same time the storage volume V₁ through their height.

In order to be able to empty the storage volume V₁ completely, an emptying medium by way of example of a valve or a pump can be provided, which enables the tank 16 to be emptied completely. This is preferably provided for the transport of the dishwasher 1 or for a long standstill time of the dishwasher 1. The emptying function can be activated either automatically after a predetermined period of time has elapsed or manually by the user. For example, by selecting a key or a combination of keys on the controller of the dishwasher 1.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 Dishwasher
2 Housing
3 Washing container
4 Washing compartment
5 Washing items
6 Washing basket
7 Collecting pot
8 Circulating pump
9 Heat pump device
10 Compressor
11 Condenser
12 Throttle
13 Evaporator
14 Flow circuit
15 Circulating system
16 Tank
17 Storage tank
18 Conduit
19 Pump
20 Water
21 Evaporator tube
22 Fresh water inlet device
23 Conduit
24 Valve
25 Overflow
26 Coat of ice
27 Thermal radiation
28 Connecting lead
29 Ice
30 Air cushion
31 Drain valve
32 Siphon
33 Annular gap
34 Wall
35 Top wall
36 Washing container bottom
37 Gap
38 Base plate
39 Hood
40 Annular wall
41 Surface
42 Surface
V₁ Nominal volume
V₂ Fill volume
V₃ Storage volume
RH Reference height
WP Water level

1: A dishwasher, in particular a household dishwasher, comprising:
a washing container comprising a washing compartment and which is configured to receive washing items to be cleaned; and
a heat pump device which has an evaporator which is arranged within a tank filled with water,
wherein the tank is fluidically connected to the washing container and to a fresh water inlet device, and
wherein the tank is arranged below the washing container and has a top wall facing a washing container bottom.

2: The dishwasher according to claim 1, wherein the top wall is oblique and/or runs substantially parallel to the washing container bottom at least in some of its sections.

3: The dishwasher according to claim 1, wherein the tank is arranged below the washing container except for a gap between the top wall and the washing container bottom, and
wherein a distance between the top wall and the washing container bottom is between 3 mm and 30 mm.

4: The dishwasher according to claim 1, wherein the tank has a first compartment and a second compartment, and
wherein the first compartment provides a nominal volume and the second compartment provides a filling volume.

5: The dishwasher according to claim 4, further comprising a storage tank fluidically connected to the tank, wherein the storage tank provides a storage volume, which storage volume is equal to or in line with the filling volume.

6: The dishwasher according to claim 5, wherein the tank is fluidically connected to the fresh water inlet device with fluidic interposition of the storage container.

7: The dishwasher according to claim 5, wherein the storage container is at least partially laterally adjacent to the washing container.

8: The dishwasher according to claim 5, wherein the tank and the storage container are formed in one piece.

9: The dishwasher according to claim 5, wherein the tank and/or the storage container are connected to a vent and/or an overflow.

10: The dishwasher according to claim 1, wherein a tank ventilation is formed at a highest point in a height direction of a particularly inclined top wall of the tank.

11: The dishwasher according to claim 1, further comprising a pump and/or a discharge valve integrated into a fluid connection between the washing container and the tank, and/or
wherein the fluid connection between the washing container and the tank comprises a siphon.

12: The dishwasher according to claim 1, wherein the tank has a base plate and a hood carried by it and providing the ceiling wall.

13: A method for operating the dishwasher according to claim 1, comprising:
supplying water located in the tank above the nominal volume to the washing container; and
after completion of operation of the heat pump device, supplying the tank with an amount of water corresponding to the filling volume.

14: The method according to claim 13, further comprising:
forming an air cushion between a surface of the water in the tank and an inside surface of the top wall of the tank at the start of a washing program,
and/or
displacing an air cushion located between a surface of the water in the tank and an inner surface of the top wall of the tank as a result of the water supply after an operation of the heat pump device has ended.

15: The method according to claim 13, further comprising:
using a storage volume provided by the storage container as a compensating volume for the tank.

16: The dishwasher according to claim 5, wherein storage tank which is arranged above the tank.

17: The dishwasher according to claim 12, wherein the tank has an annular wall received by the hood and surrounding the nominal volume.

18: The method according to claim 15, wherein the storage container temporarily stores at least some of the water to be supplied to the tank.
